(19) United States
(12) Patent Application Publication
(10) Pub. No.: US 2012/0138529 A1
(43) Pub. Date: Jun. 7, 2012

(54) METHOD AND APPARATUS FOR RECOVERING A METAL AND SEPARATING ARSENIC FROM AN ARSENIC CONTAINING SOLUTION

(75) Inventors: John L. Burba, III, Parker, CO (US); Carl R. Hassler, Gig Harbor, WA (US); C. Brock O'Kelley, Las Vegas, NV (US); Charles F. Whitehead, Las Vegas, NV (US)

(73) Assignee: MOLYCORP MINERALS, LLC, Greenwood Village, CO (US)

(21) Appl. No.: 11/958,644

(22) Filed: Dec. 18, 2007

Related U.S. Application Data
(60) Provisional application No. 60/882,376, filed on Dec. 28, 2006.

(51) Int. Cl. C02F 1/62; B01D 15/26; B01D 11/02; B01D 39/06; B01D 36/00; C25C 1/00; C01G 1/00; C01F 1/00

(52) U.S. Cl. 210/638; 210/665; 210/251; 210/195.1; 423/1; 423/179; 423/155; 205/771

(57) ABSTRACT

A method and apparatus for recovering a metal and separating arsenic from an arsenic-containing solution. The method includes contacting the arsenic-containing solution with a fixing agent that comprises a rare earth compound to produce an arsenic-depleted solution and an arsenic-laden fixing agent. The fixing agent comprises a rare earth-containing compound that can include cerium, lanthanum, or praseodymium. The fixing agent is separated from the arsenic-depleted solution and a recoverable metal is separated from one or more of the arsenic-containing solution and the arsenic-depleted solution. Recoverable metals can include metal from Group IA, Group IIA, Group VIII and the transition metals. The arsenic-containing solution can be formed by contacting an arsenic-containing material with a leaching agent. Arsenic-depleted solids formed during the leach can also be separated and recovered. An apparatus of the invention can include two or more arsenic fixing units configured to conduct the method on a continuous basis.

### FIELD OF THE INVENTION

This invention relates generally to the removal of arsenic from arsenic bearing materials, and specifically, to the fixing of arsenic from solutions formed from such materials.

### BACKGROUND OF THE INVENTION

The presence of arsenic in waters, soils and waste materials may originate from or have been concentrated through geochemical reactions, mining and smelting operations, the land-filling of industrial wastes, the disposal of chemical agents, as well as the past manufacture and use of arsenic-containing pesticides. Because the presence of high levels of arsenic may have carcinogenic and other deleterious effects on living organisms and because humans are primarily exposed to arsenic through drinking water, the U.S. Environmental Protection Agency (EPA) and the World Health Organization have set the maximum contaminant level (MCL) for arsenic in drinking water at 10 parts per billion (ppb). As a result, a problem facing industries such as mining, metal refining, steel manufacturing, glass manufacturing, chemical and petro-chemical and power generation is the reduction or removal of arsenic from process streams, effluents and byproducts.

Arsenic occurs in the inorganic form in aquatic environments primarily the result of dissolution of solid phase arsenic such as arsenolite (As₂O₃), arsenic anhydride As₂O₅) and realgar (AsS₂). Arsenic occurs in water in four oxidation or valence states, i.e., −3, 0, +3, and +5. Under normal conditions arsenic is found dissolved in aqueous or aquatic systems in the +3 and +5 oxidation states, usually in the form of arsenite (AsO₂⁻¹) and arsenate (AsO₄⁻³). The effective removal of arsenic by coagulation techniques requires the arsenic to be in the arsenate form. Arsenite, in which the arsenic exists in the +3 oxidation state, is only partially removed by adsorption and coagulation techniques because its main form, arsenious acid (HAsO₂), is a weak acid and remains un-ionized at pH levels between 5 and 8 when adsorption is place most effective.

Various technologies have been used to remove arsenic from aqueous systems. Examples of such techniques include adsorption on high surface area materials, such as alumina, activated carbon, lanthanum oxide and cerium dioxide, ion exchange with anion exchange resins, precipitation and electrodialysis. In the case of solid or semi-solid materials, attempts have been made to solidify or stabilize the arsenic in situ to prevent migration into surrounding soils or groundwater. However, because such stabilization procedures tend to be quite costly, and in some cases are unproven, there is a need for alternate methods and techniques for handing arsenic in such materials.

### SUMMARY OF THE INVENTION

In one embodiment, the present invention provides a method for recovering a metal and separating arsenic from an arsenic-containing solution. The method includes the steps of contacting an arsenic-containing solution with a fixing agent under conditions in which at least a portion of the arsenic is fixed by the fixing agent to yield an arsenic-depleted solution and an arsenic-laden fixing agent, the fixing agent comprising a rare earth-containing compound; separating the arsenic-laden fixing agent from the arsenic-depleted solution; and separating a recoverable metal from one or more of the arsenic-containing solution and the arsenic-depleted solution.

The rare earth-containing compound can include one or more of cerium, lanthanum, or praseodymium. Where the rare earth-containing compound comprises a cerium-containing compound, the cerium-containing compound can be derived from thermal decomposition of a cerium carbonate. The rare earth-containing compound can include cerium dioxide. When a recoverable metal is in solution in the arsenic-containing solution, the fixing agent comprises an insoluble compound that does not react with the recoverable metal to form an insoluble product.

The arsenic-containing solution can be contacted with the fixing agent by flowing the arsenic-containing solution through a bed of the fixing agent or by adding the fixing agent to the arsenic-containing solution. The arsenic-containing solution can have a pH of more than about 7, or more than about 9, or more than about 10, when the arsenic-containing solution is contacted with the fixing agent. In other embodiments, the arsenic-containing solution can have a pH of less than about 7, or less than about 4, or less than about 3, when the arsenic-containing solution is contacted with the fixing agent. The arsenic-containing solution can include at least about 1000 ppm inorganic sulfate when the arsenic-containing solution is contacted with the fixing agent.

One or more of the arsenic-containing solution and the arsenic-depleted solution can include a recoverable metal. The recoverable metal can include a metal from Group IA, Group IIA, Group VIII and the transition metals. Separating the recoverable metal from the arsenic-containing solution can include electrolyzing or precipitating the recoverable metal from the arsenic-containing solution. Separating the recoverable metal from the arsenic-depleted solution can include electrolyzing or precipitating the recoverable metal from the arsenic-depleted solution.

The method can optionally includes the steps of contracting an arsenic-bearing material with a leaching agent to form an arsenic-containing solution and arsenic-depleted solids, and separating the arsenic-depleted solids from the arsenic-containing solution. The leaching agent can include one or more of an inorganic salt, an inorganic acid, an organic acid, and an alkaline agent. When the arsenic-depleted solids comprise a recoverable metal, the method can optionally include the step of adding the arsenic-depleted solids to a feedstock in a metal refining process to separate the recoverable metal.

In another embodiment, the present invention provides as apparatus for recovering a metal and separating arsenic from an arsenic-containing solution. The apparatus includes an arsenic fixing unit for receiving an arsenic-containing solution. The arsenic fixing unit includes a contact zone having a fixing agent comprising a rare earth-containing compound for contacting the arsenic-containing solution and fixing at least a portion of the arsenic to yield an arsenic-depleted solution and an arsenic-laden fixing agent. The contact zone of the arsenic fixing unit can be disposed in a tank, pipe, column or other suitable vessel.

The fixing agent comprises a rare earth-containing compound. The rare earth-containing compound can include one or more of cerium, lanthanum, or praseodymium. Where the rare earth-containing compound comprises a cerium-containing compound, the cerium-containing compound can be derived from thermal decomposition of a cerium carbonate. The rare earth-containing compound can include cerium dioxide. When a recoverable metal is in solution in the arsenic-containing solution and the fixing agent comprises an insoluble compound that does not react with the recoverable metal to form an insoluble product.

A separator is provided for separating the arsenic-laden fixing agent from the arsenic-depleted solution.

The apparatus includes a metal recovery unit operably connected the arsenic fixing unit for separating a recoverable metal from one or more of the arsenic-containing solution and the arsenic-depleted solution. The metal recovery unit can include one or more of an electrolyzer and a precipitation vessel.

The apparatus can optionally further include a second arsenic fixing unit that comprises a contact zone having a fixing agent comprising a rare earth-containing compound for contacting the arsenic-containing solution and fixing at least a portion of the arsenic to yield an arsenic-depleted solution. When the apparatus includes a second fixing unit, the apparatus can include a manifold in fluid communication with an inlet of each of the arsenic fixing units for selectively controlling a flow of the arsenic-containing solution to each of the arsenic fixing units, for selectively controlling a flow of a sluce stream to each of the arsenic fixing units and/or for selectively controlling a flow of the fixing agent to each of the arsenic fixing units.

The apparatus can optionally include a leaching unit for containing an arsenic-bearing material and contacting the arsenic-bearing material with a leaching agent under conditions such that at least a portion of the arsenic is extracted to form an arsenic-containing solution and arsenic-depleted solids. A separator can be provided to separate the arsenic-containing solution from the arsenic-depleted solids.

The apparatus can optionally include a filtration unit connected to the arsenic fixing unit for receiving the arsenic-laden fixing agent and producing a filtrate. The filtration unit can optionally be in fluid communication with an inlet of the arsenic fixing unit for recycling the filtrate to the arsenic fixing unit.

### BRIEF DESCRIPTION OF THE DRAWINGS

The invention may be understood by reference to the following description taken in conjunction with the accompanying drawings.

FIG. 1 is a flow chart representation of a method of the present invention.

FIG. 2A is a schematic view of an apparatus of the present invention.

FIG. 2B is a schematic view of an apparatus of the present invention.

FIG. 3 is a schematic view of an apparatus of the present invention.

FIG. 4 is a schematic view of an apparatus of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

It will be understood that the method and apparatus disclosed herein can be used to treat any aqueous solution that contains undesirable amounts of arsenic. Examples of such solutions include, among others, well water, surface waters, such as water from lakes, ponds and wetlands, agricultural waters, industrial process streams, wastewater and effluents from industrial processes, and solutions formed from industrial waste and byproducts. Such solutions may be formed by leaching an arsenic-bearing material. Examples of such materials can include byproducts and waste materials from industries such as mining, metal refining, steel manufacturing, glass manufacturing, chemical and petrochemical, as well as contaminated soils, wastewater sludge, and the like. More specific examples can include mine tailings, mats and residues from industrial processes, soils contaminated by effluents and discharges from such processes, spent catalysts, and sludge from wastewater treatment systems. While portions of the disclosure herein refer to the removal of arsenic from mining tailings and residues from hydrometallurgical operations, such references are illustrative and should not be construed as limiting.

The arsenic-containing solution can contain other inorganic contaminants, such as selenium, cadmium, lead, mercury, chromium, nickel, copper and cobalt, and organic contaminants. The disclosed methods can remove arsenic from such solutions even when elevated concentrations of such inorganic contaminants are present. More specifically, arsenic can be effectively removed from solutions comprising more than about 1000 ppm of inorganic sulfates.

The arsenic-containing solution can also contain particularly high concentrations of arsenic. Solutions prepared from such materials can contain more than about 20 ppb arsenic and frequently contain in excess of 1000 ppb arsenic. The disclosed methods are effective in decreasing such arsenic levels to amounts less than about 20 ppb, in some cases less than about 10 ppb, in others less than about 5 ppb and in still others less than about 2 ppb.

The disclosed methods are also able to effectively fix arsenic from solution over a wide range of pH levels, as well as at extreme pH values. In contrast to many conventional arsenic removal techniques, this capability eliminates the need to alter and/or maintain the pH of the solution within a narrow range when removing arsenic. Moreover, it adds flexibility in that the selection of materials and processes for leaching arsenic from an arsenic-bearing material can be made without significant concern for the pH of the resulting arsenic-containing solution. Further still, elimination of the need to adjust and maintain pH while fixing arsenic from an arsenic-containing solution provides significant cost advantages.

In one aspect of the present invention, a method is provided for recovering a metal and separating arsenic from an arsenic-containing solution. The method includes the steps of contacting an arsenic-containing solution with a fixing agent under conditions in which at least a portion of the arsenic is fixed by the fixing agent to yield an arsenic-depleted solution and an arsenic-laden fixing agent, the fixing agent comprising a rare earth-containing compound; separating the arsenic-laden fixing agent from the arsenic-depleted solution; and separating a recoverable metal from one or more of the arsenic-containing solution and the arsenic-depleted solution.

The arsenic-containing solution is contacted with the fixing agent in a tank, container or other vessel suitable for holding such solutions and materials. The solution is at a temperature and pressure, usually ambient conditions, such that the solution remains in the liquid state. Elevated temperature and pressure conditions may be used. The tank may optionally include a mixer or other means for promoting agitation and contact between the arsenic-containing solution and fixing agent. Non-limiting examples of suitable vessels are described in U.S. Pat. No. 6,383,395, which description is incorporated herein by reference.

The fixing agent can be any rare earth-containing compound that is effective at fixing arsenic in solution through precipitation, adsorption, ion exchange or other mechanism. The fixing agent can be soluble, slightly soluble or insoluble in the aqueous solution. In some embodiments, the fixing agent has a relatively high surface area of at least about 70 m³/g, and in some cases more than about 80 m³/g, and in still other cases more than 90 m³/g. The fixing agent can be substantially free of arsenic prior to contacting the arsenic-containing solution or can be partially-saturated with arsenic. When partially-saturated, the fixing agent can comprise between about 0.1 mg and about 80 mg of arsenic per gram of fixing agent.

The fixing agent can include one or more of the rear earths including lanthanum, cerium, praseodymium, neodymium, promethium, samarium, europium, gadolinium, terbium, dysprosium, holmium erbium, thulium, ytterbium and lutetium. Specific examples of such materials that have been described as being capable of removing arsenic from aqueous solutions include trivalent lanthanum compounds (U.S. Pat. No. 4,046,687), soluble lanthanide metal salts (U.S. Pat. No. 4,566,975), lanthanum oxide (U.S. Pat. No. 5,603,838), lanthanum chloride (U.S. Pat. No. 6,197,201), mixtures of lanthanum oxide and one or more other rare earth oxides (U.S. Pat. No. 6,800,204), cerium oxides (U.S. Pat. No. 6,862,825); mesoporous molecular sieves impregnated with lanthanum (U.S. Patent Application Publication No. 20040050795), and polyacrylonitrile impregnated with lanthanide or other rare earth metals (U.S. Patent Application Publication No. 20050051492). It should also be understood that such rare earth-containing fixing agents may be obtained from any source known to those skilled in the art.

In some embodiments, the rare-earth containing compound can comprise one or more of cerium, lanthanum, or praseodymium. Where the fixing agent comprises a compound containing cerium, the fixing agent can be derived from cerium carbonate. More specifically, such a fixing agent can be prepared by thermally decomposing a cerium carbonate or cerium oxalate in a furnace in the presence of air. When the fixing agent comprises cerium dioxide, it is generally preferred to use solid particles of cerium dioxide, which are insoluble in water and relatively attrition resistant. Water-soluble cerium compounds such as ceric ammonium nitrate, ceric ammonium sulfate, ceric sulfate, and ceric nitrate can also be used as the fixing agent, particularly where the concentration of arsenic in solution is high.

The rare earth-containing fixing agents of the present invention are particularly advantageous in their ability to remove arsenic from solution over a wide range of pH values and at extreme pH values. The pH of the arsenic-containing solution can be less than about 7 when the arsenic-containing solution is contacted with the first portion of fixing agent. More specifically, the pH of the arsenic-containing solution can be less than about 4, and still more specifically, the pH of the arsenic-containing solution can be less than about 3 when the arsenic-containing solution is contacted with the first portion of fixing agent. In other embodiments, the pH of the arsenic-containing solution can be more than about 7 when the arsenic-containing solution is contacted with the first portion of fixing agent. More specifically, the pH of the arsenic-containing solution can be more than about 9, and still more specifically, the pH of the arsenic-containing solution can be more than about 10 when the arsenic-containing solution is contacted with the first portion of fixing agent.

To the extent that it is desirable to adjust or control the pH, an optional acid and/or alkaline addition may be added to the solution as is well known in the art. Acid addition can include the addition of a mineral acid such as hydrochloric or sulfuric acid. Alkaline addition can include the addition of sodium hydroxide, sodium carbonate, calcium hydroxide, ammonium hydroxide and the like.

Where the recoverable metal is in solution in the arsenic containing solution, the fixing agent is preferably an insoluble compound that selectively adsorbs arsenic from the solution and does not react or reacts only weakly with the recoverable metal to form an insoluble product.

Optionally, a fixing agent that does not contain a rare earth compound can also be used. Such optional fixing agents can include any solid, liquid or gel that is effective at fixing arsenic in solution through precipitation, adsorption, ion exchange or some other mechanism. These optional fixing agents can be soluble, slightly soluble or insoluble in the aqueous solution. Optional fixing agents can include particulate solids that contain cations in the +3 oxidation state that react with the arsenate in solution to form insoluble arsenate compounds. Examples of such solids include alumina, gamma-alumina, activated alumina, acidified alumina such as alumina treated with hydrochloric acid, metal oxides containing labile anions such as aluminum oxychloride, crystalline alumino-silicates such as zeolites, amorphous silica-alumina, ion exchange resins, clays such as montmorillonite, ferric salts, porous ceramics. Optional fixing agents can also include calcium salts such as calcium chloride, calcium hydroxide, and calcium carbonate, and iron salts such as ferric salts, ferrous salts, or a combination thereof. Examples of iron-based salts include chlorides, sulfates, nitrates, acetates, carbonates, iodides, ammonium sulfates, ammonium chlorides, hydroxides, oxides, fluorides, bromides, and perchlorates. Where the iron salt is a ferrous salt, a source of hydroxyl ions may also be required to promote the co-precipitation of the iron salt and arsenic. Such a process and materials are described in more detail in U.S. Pat. No. 6,177,015, issued Jan. 23, 2001 to Blakey et al. Other optional fixing agents are known in the art and may be used in combination with the rare earth-containing fixing agents described herein. Further, it should be understood that such optional fixing agents may be obtained from any source known to those skilled in the art.

The arsenic-laden fixing agent is separated from an arsenic-depleted solution in a separator. One or more steps may be required to separate the solution from such liquids solids. A variety of options are available, including screening, settling, filtration, and centrifuging, depending on the size and physical characteristics of the solids.

Particulate solids such as insoluble fixing agents and insoluble arsenic-containing compounds can be separated from the various solutions described herein for further processing. Any liquid-solids separation technique, such as screening, filtration, gravity settling, centrifuging, hydrocycloning or the like can be used to remove such particulate solids. An optional flocculant, coagulant or thickener can also be added to the solution before the particulate solids are removed. Such agents are useful for achieving a desired particle size and improving the settling properties of the arsenic-laden fixing agent. Examples of inorganic coagulants include ferric sulfate, ferric chloride, ferrous sulfate, aluminum sulfate, sodium aluminate, polyaluminum chloride, aluminum trichloride among others. Organic polymeric coagulants and flocculants can also be used, such as polyacrylamides (cationic, nonionic, and anionic), EPI-DMA's (epichlorohydrin-dimethylamines), DADMAC's (polydiallydimethyl-ammonium chlorides), dicyandiamide/formaldehyde polymers, dicyandiamide/amine polymers, natural guar, etc.

The arsenic laden fixing agent can optionally be directed to a filtration unit that is connected to the separator wherein the fixing agent is filtered to produce a filtrate and arsenic-laden solids. The solids are directed out of the filtration unit for appropriate disposal or further handling. The filtration unit has an outlet in fluid communication with the arsenic fixing unit for recycling the filtrate to the contract zone where it is combined with in-coming fresh arsenic-containing solution and contacted with fixing agent.

The methods of the present invention include the step of separating a recoverable metal from one or more of the arsenic-containing solution and the arsenic-depleted solution. As used herein, recoverable metal can include virtually any metal of interest, but specifically includes metals from Group IA, Group IIA, Group VIII, and the transition metals.

The recoverable metal can be separated from an arsenic-containing solution and/or an arsenic-depleted solution by a variety of methods. The solution can be combined with a process stream or added to the feedstock in a metal refining process, such as one utilizing electrochemical methods. By way of example, the separation of various metals through electrorefining processes is described in detail in U.S. Pat. No. 6,569,224 issued May 27, 2003 to Kerfoot et al. Electrowinning or electrorefining are widely used processes for recovering and refining copper, nickel, zinc, lead, cobalt, and manganese dioxide.

Another method for separating a recoverable metal from the arsenic-containing solution includes precipitating the recoverable metal from the solution. Precipitation reactions are widely used to recover metal values or to remove impurities from process streams and waste waters. Many hydrometallurgical processes contain one or more precipitation steps. For instance, hydroxide is used to precipitate iron from acid streams, neutralize acid streams for disposal, recover nickel and cobalt hydroxide from sulfate liquors, and remove metals from wastewater. Platinum group metals are also recovered from acidic leach solutions by precipitation. Sulfide is another common compound used in precipitation steps. Hydrogen sulfide is used to recover copper from copper-bearing streams and nickel and cobalt from acid sulfate liquors. Sodium hydrosulfide and calcium sulfide are widely used to remove zinc, copper, lead, silver, and cadmium from waste streams. Therefore, an apparatus of the invention can optionally include a precipitation vessel. In such an embodiment, a separator as described herein can optionally be used to separate precipitated metals from the arsenic-containing solution. A more detailed description of precipitation in hydrometallurgical operations may be had by reference to www.hazenusa.com.

In some embodiments, the arsenic-containing solution is optionally prepared by leaching the arsenic from an arsenic-bearing material. The arsenic-bearing material is contacted with an arsenic leaching agent to form an arsenic-containing solution and arsenic-depleted solids. Arsenic can be leached from solids such as contaminated soils, industrial byproducts and waste materials by leaching or extraction to release the arsenic from such solids. Within the mining and hydrometallurgical industries, leaching refers to the dissolution of metals or other compounds of interest from an ore or other solid into an appropriate solution. Depending on the nature of the arsenic-bearing materials, pretreatment or processing such as by grinding or milling, may be desired to promote dissolution and release of arsenic.

The arsenic leaching agent can include one or more of an inorganic salt, an inorganic acid, an organic acid and an alkaline agent. The selection of the leaching agent will depend on the nature of the arsenic-bearing material and other compounds that are present. Specific examples of inorganic salt leaching agents include potassium salts such as potassium phosphate, potassium chloride, potassium nitrate, potassium sulfate, sodium perchlorate and the like. Examples of inorganic acids that may be used to leach arsenic from solids include sulfuric acid, nitric acid, phosphoric acid, hydrochloric acid, perchloric acid and mixtures thereof. Organic acid leaching agents can include citric acid, acetic acids and the like. Alkaline agents can include sodium hydroxide among others. A more detailed description of arsenic leaching agents and their use may be had by reference to M. Jang et al., “Remediation Of Arsenic-Contaminated Solids And Washing Effluents”, Chemosphere, 60, pp 344-354, (2005); M. G. M. Alam et al., “Chemical Extraction of Arsenic from Contaminated Soil”, J. Environ Sci Health A Tox Hazard Subst Environ Eng., 41 (4), pp 631-643 (2006); and S. R. Al-Abed et al., “Arsenic Release From Iron Rich Mineral Processing Waste; Influence of pH and Redox Potential”, Chemosphere, 66, pp 775-782 (2007).

The arsenic-bearing material is contacted with the leaching agent to form a slurry in a tank, container or other vessel suitable for holding such solutions and materials. Pumps, mixers or other suitable means may be included for promoting agitation and contact between the leaching agent and the arsenic-bearing materials. More specifically, the arsenic-bearing material can be contacted with the arsenic leaching agent in an open tank, a pressure vessel at elevated temperatures, or by flowing or percolating the leaching agent through arsenic-bearing material and collecting the arsenic-containing solution that issues therefrom. Where the leach requires elevated temperatures and pressures to achieve the desired arsenic extraction, an autoclave may be used. Examples of this include pressure oxidation of sulfide-containing ores and concentrates, high-pressure acid leaching of nickel laterites, and wet-air oxidation of organics. Batch and continuous reactors constructed from stainless steel, titanium and other corrosive resistant materials are commercially available for such processes. A more detailed description of leaching in hydrometallurgical applications may be had by reference to www.hazenusa.com.

Following the arsenic leach, the arsenic-containing solution is separated from insoluble materials, referred to herein as arsenic-depleted solids. One or more steps may be required to separate the solution from such liquids solids. A variety of options are available, including screening, settling, filtration, and centrifuging, depending on the size and physical characteristics of the solids.

In another embodiment, the present invention provides as apparatus for recovering a metal and separating arsenic from an arsenic-containing solution. The apparatus includes an arsenic fixing unit for receiving an arsenic-containing solution. The arsenic fixing unit includes a contact zone having a fixing agent comprising a rare earth-containing compound for contacting the arsenic-containing solution and fixing at least a portion of the arsenic to yield an arsenic-depleted solution and an arsenic-laden fixing agent. The contact zone of the arsenic fixing unit can be disposed in a tank, pipe, column or other suitable vessel.

The fixing agent comprises a rare earth-containing compound. The rare earth-containing compound can include one or more of cerium, lanthanum, or praseodymium. Where the rare earth-containing compound comprises a cerium-containing compound, the cerium-containing compound can be derived from thermal decomposition of a cerium carbonate. The rare earth-containing compound can include cerium dioxide. When a recoverable metal is in solution in the arsenic-containing solution and the fixing agent comprises an insoluble compound that does not react with the recoverable metal to form an insoluble product.

A separator is provided for separating the arsenic-laden fixing agent from the arsenic-depleted solution.

The apparatus includes a metal recovery unit operably connected the arsenic fixing unit for separating a recoverable metal from one or more of the arsenic-containing solution and the arsenic-depleted solution. The metal recovery unit can include one or more of an electrolyzer and a precipitation vessel.

The apparatus can optionally further include a second arsenic fixing unit that comprises a contact zone having a fixing agent comprising a rare earth-containing compound for contacting the arsenic-containing solution and fixing at least a portion of the arsenic to yield an arsenic-depleted solution. When the apparatus includes a second fixing unit, the apparatus can include a manifold in fluid communication with an inlet of each of the arsenic fixing units for selectively controlling a flow of the arsenic-containing solution to each of the arsenic fixing units, for selectively controlling a flow of a sluce stream to each of the arsenic fixing units and/or for selectively controlling a flow of the fixing agent to each of the arsenic fixing units.

The apparatus can optionally include a leaching unit for contacting the arsenic-bearing material with a leaching agent under conditions such that at least a portion of the arsenic is extracted to form an arsenic-containing solution and arsenic-depleted solids. A separator can be provided to separate the arsenic-containing solution from the arsenic-depleted solids.

The apparatus can optionally include a filtration unit connected to the arsenic fixing unit for receiving the arsenic-laden fixing agent and producing a filtrate. The filtration unit can optionally be in fluid communication with an inlet of the arsenic fixing unit for recycling the filtrate to the arsenic fixing unit.

### DETAILED DESCRIPTION OF THE FIGURES

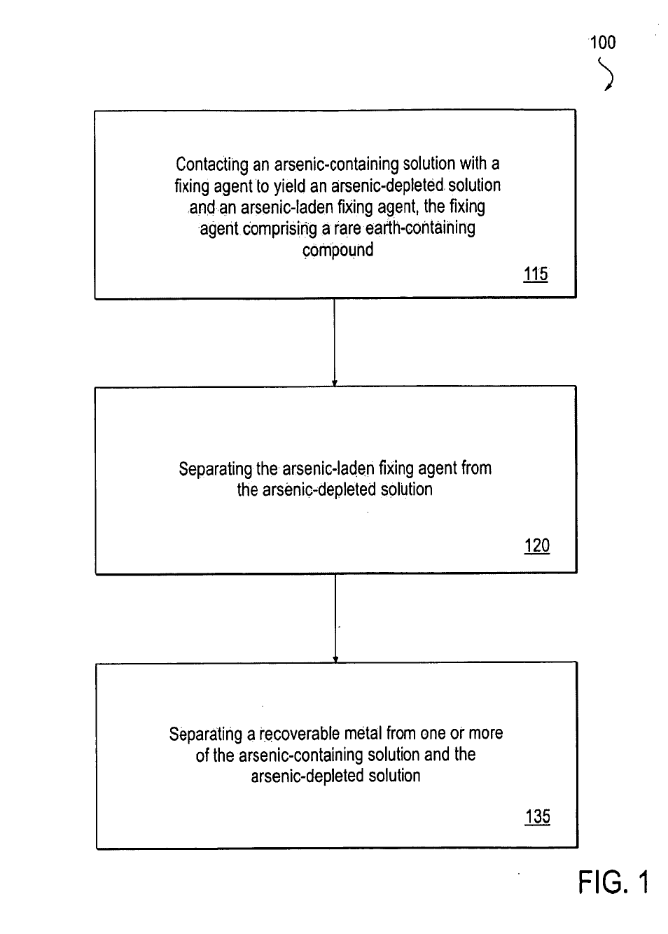

FIG. 1 is a flow chart representation of method 100. Method 100 includes step 115 of arsenic-containing solution is contacted with fixing agent under conditions in which at least a portion of the arsenic is fixed by the fixing agent to yield an arsenic-depleted solution and an arsenic-laden fixing agent, the fixing agent comprises a rare earth-containing compound. In step 120, the arsenic-laden fixing agent is separated from the arsenic-depleted solution. In step 135, a recoverable metal is separated from one or more of the arsenic-containing solution or the arsenic-depleted solution.

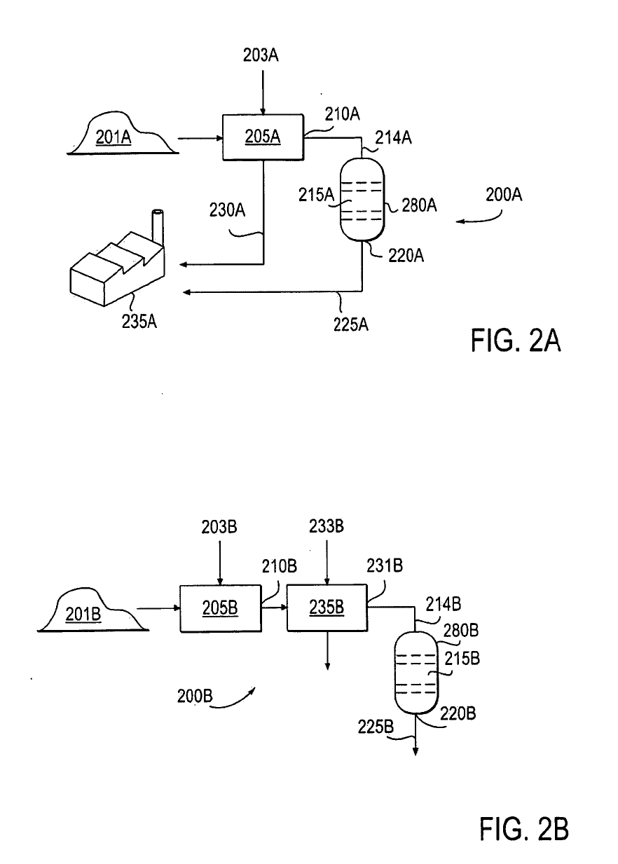

FIG. 2A is a schematic view of apparatus 200A. Apparatus 200A includes optional leaching unit 205A for preparing an arsenic-containing solution from arsenic-bearing material 201A. Arsenic-depleted solids can optionally be conveyed on line 230A to metal recovery unit 235A. The arsenic-containing solution is directed to fixing unit 280A, which has contact zone 215A. The fixing agent in contact zone 215A fixes and removes arsenic from the solution to yield an arsenic-depleted solution. Separator 220A separates the arsenic-depleted solution from the arsenic-laden fixing agent. The arsenic depleted solution is directed to metal recovery unit 235A through line 225A.

FIG. 2B is a schematic view of apparatus 200B. Apparatus 200B includes optional leaching unit 205B for preparing an arsenic-containing solution from arsenic-bearing material 201B. The arsenic-containing solution is directed to precipitation vessel 235B where a recoverable metal is precipitated from the arsenic-containing solution. The arsenic-containing solution is separated from the precipitated metals by separator 231B and directed to fixing unit 280B through line 214B. Fixing unit 280B has contact zone 215B. The fixing agent in contact zone 215B fixes and removes arsenic from the solution to yield an arsenic-depleted solution. Separator 220B separates the arsenic-depleted solution from the arsenic-laden fixing agent, which is directed out of the fixing unit through line 225B.

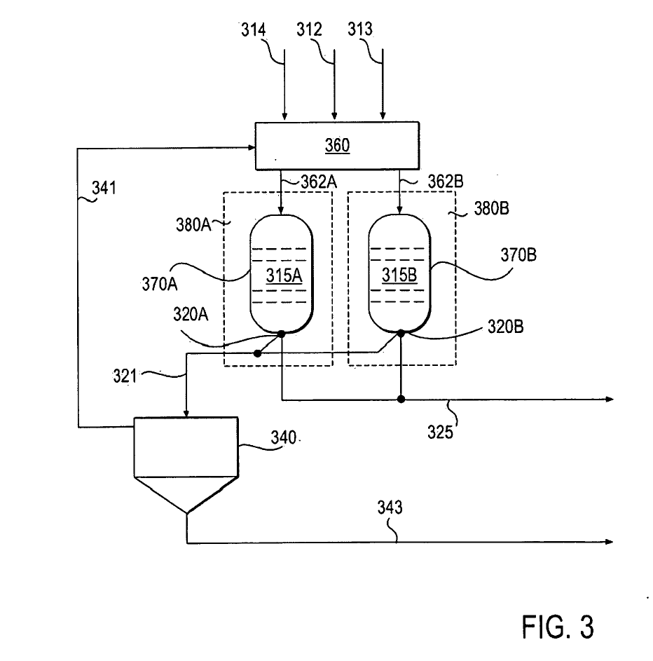

FIG. 3 is a schematic view of apparatus 300 that includes arsenic fixing units 380A and 380B and filtration unit 340. As illustrated, the apparatus 300 includes manifold 360 and a plurality of columns 370A and 370B. The columns have contact zones 315A and 315B and separators 320A and 320B, respectively. Manifold 360 receives arsenic-containing solution through line 314, a sluce solution through line 312 and fresh fixing agent through line 313. Manifold 360 selectively controls the flow of each of these materials to columns 370A and 370B through lines 362A and 362B respectively. Valves (not shown) at the bottom of each of columns 370A and 370B control the flow of arsenic-depleted solution or arsenic-laden fixing agent from the columns.

When the fixing agent in column 370A is saturated and requires replacement, manifold 360 interrupts the flow of arsenic-containing solution to column 370A. The valve (not shown) at the bottom of column 370A is actuated to allow the arsenic-laden fixing agent to flow out through line 321 to filtration unit 340. Manifold 360 directs a sluce stream or solution into column 370A to wash residual fixing agent from the column. The slurried fixing agent is likewise directed to filtration unit 340 where a filtrate and arsenic-laden solids are produced. The filtrate is directed back to manifold 360 through line 341 where it is combined with fresh arsenic-containing solution entering the manifold. The arsenic-laden solids are conveyed out of filtration unit 340 on line 343 for disposal or handling. The valve is at the bottom of column 370A is closed and manifold 360 directs a flow of fresh fixing agent into contact zone 315A. While this operation is underway, manifold 360 maintains the flow of arsenic-containing solution into column 370B so as to achieve a continuous process for removing arsenic from the solution. The arsenic-depleted solution separated from the fixing agent in column 370B is then directed out through line 325 for further processing or disposal.

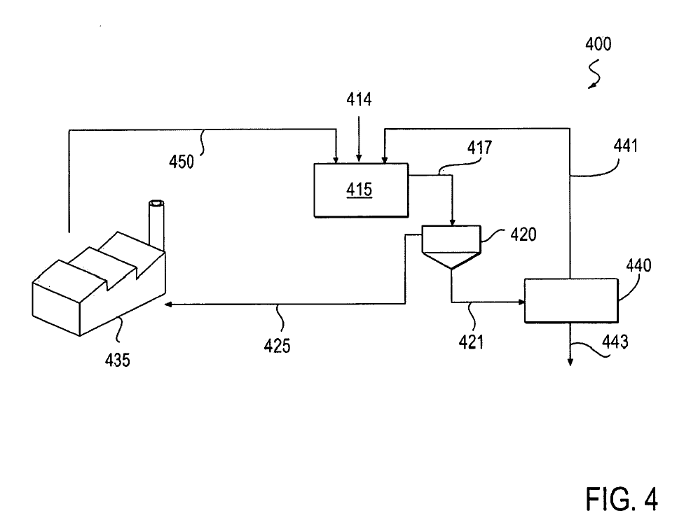

FIG. 4 illustrates apparatus 400 that includes tank 415, separator 420, filtration unit 440 and metal recovery unit 435. An arsenic-containing solution is directed into tank 415 containing a fixing agent. The fixing agent produces an arsenic-depleted solution and an arsenic-laden fixing agent that are directed through line 417 to separator 220. The arsenic-laden fixing agent settles to the bottom and the arsenic-depleted solution is directed through an overflow outlet into line 425 and directed to metal recovery unit 435. The arsenic laden fixing agent is directed through line 421 to a filtration unit where a filtrate and arsenic-laden solids are produced. The solids are directed out of the filtration unit through line 443 and the filtrate is recycled to an inlet of tank 415. Optionally, where the metal recovery unit produces an arsenic-containing solution, that solution can be directed to an inlet of tank 415 though line 450.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for recovering a metal and separating arsenic from an arsenic-containing solution, the method comprising the steps of:
contacting an arsenic-containing solution with a fixing agent under conditions in which at least a portion of the arsenic is fixed by the fixing agent to yield an arsenic-depleted solution and an arsenic-laden fixing agent, the fixing agent comprising a rare earth-containing compound;
separating the arsenic-laden fixing agent from the arsenic-depleted solution; and
separating a recoverable metal from one or more of the arsenic-containing solution and the arsenic-depleted solution.

2. The method of claim 1, wherein the recoverable metal comprises a metal from Group IA, Group IIA, Group VIII and the transition metals.

3. The method of claim 1, further comprising the step of contacting an arsenic-containing material with a leaching agent to form the arsenic-containing solution.

4. The method of claim 3, wherein the leaching agent comprises one or more of an inorganic salt, an inorganic acid, an organic acid and an alkaline agent.

5. The method of claim 4, wherein the alkaline agent comprises sodium hydroxide.

6. The method of claim 3, wherein the step of contacting an arsenic-containing material with the leaching agent produces arsenic-depleted solids comprising a recoverable metal, the method further comprising adding the arsenic-depleted solids to a feedstock in a metal refining process.

7. The method of claim 1, wherein the arsenic-containing solution has a pH of more than about 7, prior to contacting the arsenic-containing solution with the fixing agent.

8. The method of claim 7, wherein the arsenic-containing solution has a pH of more than about 9, prior to contacting the arsenic-containing solution with the fixing agent.

9. The method of claim 8, wherein the arsenic-containing solution has a pH of more than about 10, prior to contacting the arsenic-containing solution with the fixing agent.

10. The method of claim 1, wherein the arsenic-containing solution has a pH of less than about 7, prior to contacting the arsenic-containing solution with the fixing agent.

11. The method of claim 10, wherein the arsenic-containing solution has a pH of less than about 4, prior to contacting the arsenic-containing solution with the fixing agent.

12. The method of claim 11, wherein the arsenic-containing solution has a pH of less than about 3, prior to contacting the arsenic-containing solution with the fixing agent.

13. The method of claim 1, wherein the recoverable metal is in solution and the fixing agent comprises an insoluble compound that does not react with the recoverable metal to form an insoluble product.

14. The method of claim 13, wherein the rare earth-containing compound comprises one or more of cerium, lanthanum, or praseodymium.

15. The method of claim 14, wherein the rare earth-containing compound comprises a cerium-containing compound derived from thermal decomposition of a cerium carbonate.

16. The method of claim 14, wherein the rare earth-containing compound comprises cerium dioxide.

17. The method of claim 1, wherein the arsenic-depleted solution comprises arsenic in an amount of less than about 20 ppm.

18. The method of claim 1, wherein the arsenic-containing solution is contacted with a fixing agent by flowing the arsenic-containing solution through a bed of the fixing agent.

19. The method of claim 1, wherein the arsenic-containing solution is contacted with a fixing agent by adding the fixing agent to the arsenic-containing solution.

20. The method of claim 1, further comprising the step of precipitating the recoverable metal from one or more of the arsenic-containing solution and the arsenic-depleted solution.

21. The method of claim 1, further comprises the step of electrolyzing one or more of the arsenic-containing solution and the arsenic-depleted solution to separate the recoverable metal.

22. An apparatus for recovering a metal and separating arsenic from an arsenic-containing solution, the apparatus comprising:
an arsenic fixing unit for receiving an arsenic-containing solution, the arsenic fixing unit comprising a contact zone having a fixing agent comprising a rare earth-containing compound for contacting the arsenic-containing solution and fixing at least a portion of the arsenic to yield an arsenic-depleted solution and an arsenic-laden fixing agent; and
a separator for separating the arsenic-laden fixing agent from the arsenic-depleted solution; and
a metal recovery unit operably connected to the arsenic fixing unit for separating a recoverable metal from one or more of the arsenic-containing solution or the arsenic-depleted solution.

23. The apparatus of claim 22, wherein the fixing agent comprises an insoluble compound that does not react with the recoverable metal to form an insoluble product.

24. The apparatus of claim 22, wherein the rare earth-containing compound comprises one or more of cerium, lanthanum, or praseodymium.

25. The apparatus of claim 24, wherein the rare earth-containing compound comprises a cerium-containing compound derived from cerium carbonate.

26. The apparatus of claim 24, wherein the rare earth-containing compound comprises cerium dioxide.

27. The apparatus of claim 22, wherein the metal recovery unit comprises an electrolyzer.

28. The apparatus of claim 22, wherein the metal recovery unit comprises a precipitation vessel.

29. The apparatus of claim 22, further comprising a filtration unit connected to the arsenic fixing unit for receiving the arsenic-laden fixing agent and producing a filtrate.

30. The apparatus of claim 26, wherein the filtration unit is in fluid communication with an inlet of the arsenic fixing unit for recycling the filtrate to the arsenic fixing unit.

31. The apparatus of claim 22, wherein the contact zone is disposed in a column.

32. The apparatus of claim 22, further comprising a second arsenic fixing unit comprising:
a contact zone having a fixing agent comprising a rare earth-containing compound for contacting the arsenic-containing solution and fixing at least a portion of the arsenic to yield an arsenic-depleted solution and an arsenic-laden fixing agent; and
a separator for separating the arsenic-laden fixing agent from the arsenic-depleted solution.

33. The apparatus of claim 32, further comprising a manifold in fluid communication with an inlet of each of the arsenic fixing units for selectively controlling a flow of the arsenic-containing solution to each of the arsenic fixing units.

34. The apparatus of claim 32, further comprising a manifold in fluid communication with an inlet of each of the arsenic fixing units for selectively controlling a flow of a sluce stream to each of the arsenic fixing units.

35. The apparatus of claim 32, further comprising a manifold in fluid communication with an inlet of each of the arsenic fixing units for selective controlling a flow of the fixing agent to each of the arsenic fixing units.
